(19) United States
(12) Patent Application Publication
(10) Pub. No.: US 2005/0108767 A1
(43) Pub. Date: May 19, 2005

(54) Device and method for instant messaging between TV viewer

(76) Inventor: Yu-Ming Ma, Taipei Hsien (TW)

Correspondence Address: SUPREME PATENT SERVICES, POST OFFICE BOX 2339, SARATOGA, CA, 95070, US

(21) Appl. No.: 10/992,246

(22) Filed: Nov. 17, 2004

(30) Foreign Application Priority Data
Nov. 17, 2003 (TW) 92132158

(51) Int. Cl. H04N 7/173; G06F 13/00; H04N 5/445; G06F 3/00; H04N 7/16

(52) U.S. Cl. 725/105; 725/30; 725/100

(57) ABSTRACT

An instant messaging device is provided specifically for TV viewers sharing a common preference. The device contains a reception module, a registration module, a list management module, and an IM module. The reception module is for receiving video programs along with their channel IDs and operator IDs. The registration module is to register the user ID, channel ID, and operator ID and obtain the accessibility to a viewer list. The list management module searches the viewer list to establish a fellow viewer list. The IM module is for conducting IM sessions with those who are on the fellow viewer list.

### BACKGROUND OF THE INVENTION

1. Field of the Invention

The present invention generally relates to instant messaging and, more particularly, to a device and method for instant messaging between TV viewers.

2. The Prior Arts

Instant messaging (IM) via service providers, such as ICQ®, MSN®, and Yahoo!®, has become a very popular means for communications between friends and colleagues. A lot of people also use IM as a way to make new friends. However, currently the service providers only provide limited search capability, such as based on age or hobbies, for finding other people.

For two parties made into contact in this way, due to the lack of a common foundation, often they can only exchange trivial greetings. Meaningful discussion is usually rare and rather unlikely.

Accordingly, a need has arisen for IM, users to better locate people sharing the same interests and having a common topic to talk about with them.

### SUMMARY OF THE INVENTION

An objective of the present invention is to provide an IM device with which TV viewers can reach other TV viewers having common program preferences via the Internet.

Another objective of the present invention is to provide an IM device so that TV viewers sharing common program preferences could conduct IM sessions via the Internet.

Based on the foregoing objectives, the present invention provides an IM device that receives video programs from an operator and interacts with an IM server on the Internet. The IM device comprises a reception module, a registration module, a list management module, and an IM module.

The reception module receives video programs from the operator. Along with the video program received by the reception module is a channel ID and an operator ID. The registration module makes a registration on the IM server by providing user information including a user ID, and the channel ID and operator ID of the video program the user is viewing. After the registration procedure, the reception module could access a viewer list on the IM server to establish a fellow viewer list. The fellow viewer list contains multiple IDs of users who are viewing the same video program and could be reached via the IM server. The IM module then can be used to conduct IM sessions with one or more of the fellow viewers in the list.

Using the IM device of the present invention, a user could more accurately locate other IM users who is watching a specific video program, find out the characteristics of the video programs they typically watch, and conduct IM sessions with them.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing a system of fellow viewers using the IM devices according to the present invention.

FIG. 2 is a schematic diagram showing the various components of the IM device and the IM server according to the present invention

FIG. 3 is a schematic diagram showing the operator and channel list according to the present invention.

FIG. 4 is a schematic diagram showing the program schedule according to the present invention.

FIG. 5 is a schematic diagram showing the user interface of the IM device according to the present invention.

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

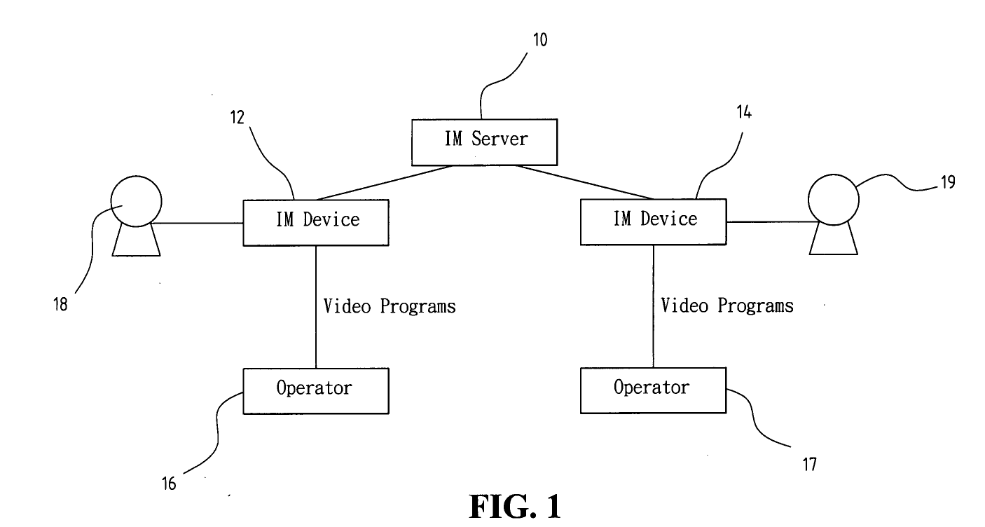

FIG. 1 is a schematic diagram showing a system of fellow viewers using the IM devices according to the present invention. As shown in FIG. 1, the IM devices 12 and 14 are used by the users 18 and 19 to receive video programs from the operators 16 and 17, respectively. In other embodiment of the present invention, the operators 16 and 17 could actually be the same operator.

Within the structure shown in FIG. 1, when all users have completed the registration process on the IM server 10 through their IM devices, a user 19, for example, could conduct a search process on the IM server 10 through the IM device 14 based on the video program information. Then, based on the result from the search process, the user 19 could generate a list of fellow viewers that can be reached via IM in the IM device 14. The user 19 could consequently conduct an IM session with another user in the list. In the following, the components of the IM device 14 and the IM server 10 are described and how the registration and search processes are carried out by these components are explained as well.

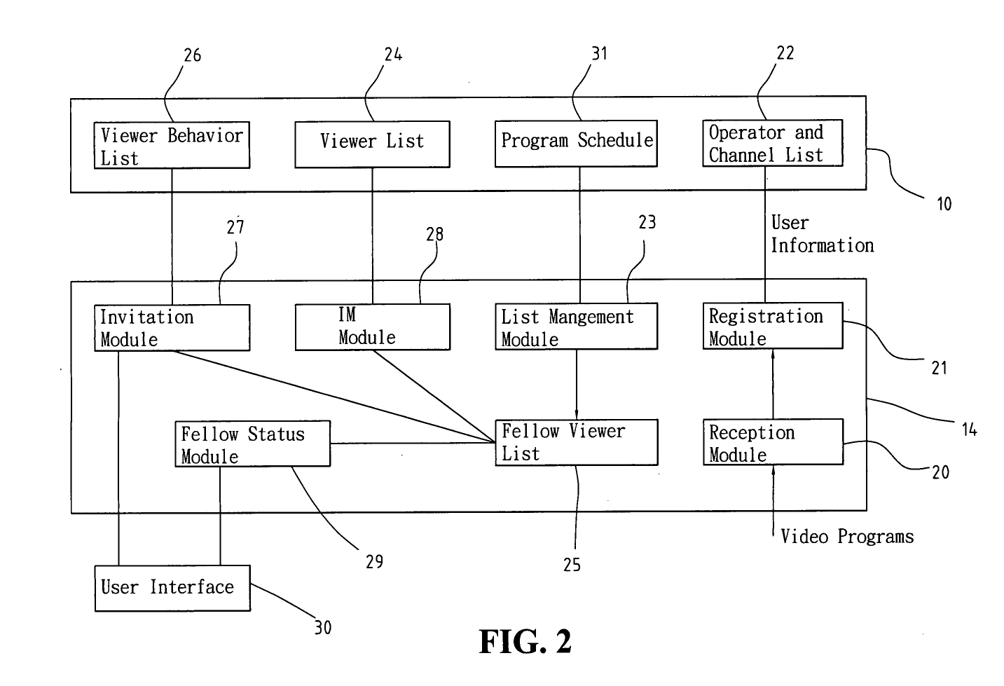

FIG. 2 is a schematic diagram showing the various components of the IM device and the IM server according to the present invention. As shown in FIG. 2, the IM device 14 contains a reception module 20, a registration module 21, a list management module 23, and an IM module 28. On the other hand, the IM server 10 contains an operator and channel list 22, a viewer list 24, program schedule 31, and viewer behavior list 26. The IM server 10 also contains invitation module 27, fellow status module 29, and user interface 30, which will be explained later. Please be noted that, since all IM devices would function identically, the IM device 19 is used as an example in the following.

As shown in FIGS. 1 and 2, the reception module 20 receives a video program on a channel from the operator 17. In addition to the video program content, the reception module 20 would also receive a channel ID (e.g., 50) and an operator ID (e.g., AAA).

The registration module 21 registers on the IM server 10 with information such as the user 19's user ID (e.g., “john”), the channel ID (e.g., “50”), and the operator ID (e.g., “AAA”). After the registration process, the registration module 21 could access the viewer list 24 on the IM server 10. Please be noted that, as the user 19 could switch and view different video programs received by the IM device 14 at any time and when that happens, the registration module 21 would re-register immediately so that the viewer list 24 would always to up to date.

The list management module 23 conducts a search process in the viewer list 24 by the IM server 10, and establishes a fellow viewer list 25 in the IM device 14. The fellow viewer list 25 contains multiple IDs of users who is watching the same video program and can be reached via the IM server 10. The IM module 28 then is used to communicate with a user (such as user 18 in FIG. 1) in the fellow viewer list 25 via the IM server 10. The components of the IM server 10 are described as follows.

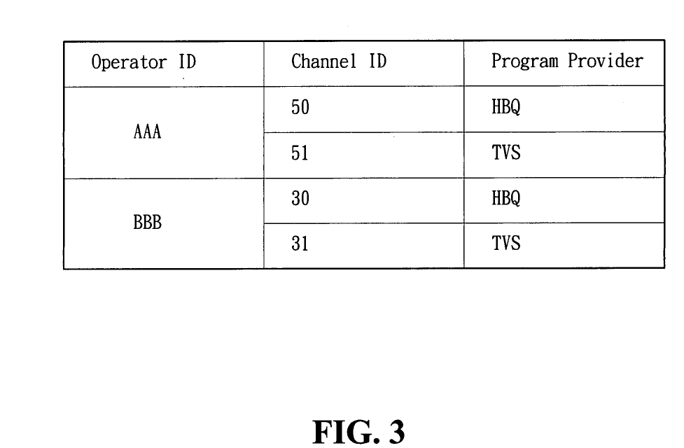

FIG. 3 is a schematic diagram showing the operator and channel list according to the present invention. As shown in FIG. 3, the operator and channel list 22 contains multiple records, each of which includes information such as operator ID, channel ID, and program provider. For example, the operator 18 of FIG. 1 has an ID “BBB” and its channel “30” is from the provider “HBQ.” On the other hand, the same program provider “HBQ” is broadcast in channel “50” of the operator 19 (whose ID is “AAA”). Therefore, the operator and channel list 22 is used to solve the operator inconsistency in their channel assignment.

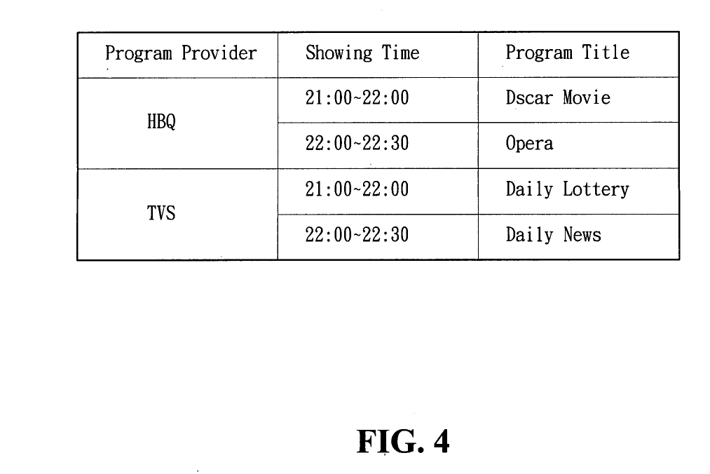

FIG. 4 is a schematic diagram showing the program schedule according to the present invention. As shown in FIG. 4, the program schedule 31 contains multiple records of program titles and their corresponding showing times. For example, the program provider “HBQ” has a program called “Oscar Movie” between 21:00-22:00.

The viewer list 24 contains multiple records, each of which keeps track of what program from which program provider that a user is watching. In other words, the viewer list 24 is generated by the aforementioned registration process, and each record of the viewer list 24 has a user ID, the name of the program provider, and the program title. On the other hand, the viewer behavior list 26 keeps track of a user's viewing preference. The viewer behavior list 26 is generated by the IM server 10 based on information collected from another registration process of the IM devices. Please be noted that the two registration processes could be conducted simultaneously or separately. In the following, the two registration processes and the search process will be described in details.

In the first registration process, the IM server 10 receives the user 19's user ID “john,” the channel ID “50,” and the operator ID “AAA” from the IM device 14. Based on the operator and channel list 22, the IM server 10 is able to find out that the user 19 is watching a program from the program provider “HBQ.” Then based on the program schedule 31 and the current time, for example 21:25, the IM server 10 could further find out that the user 19 is watching the program called “Oscar Movie.” The IM server 10 then records the user ID “john,” the program provider “HBQ,” and the program title “Oscar Movie” in the viewer list 24.

Assuming that the user 18 (whose user ID is “mary”) has also conducted the same registration process by the IM device 12, the IM server therefore knows that the user 18 is watching the channel “30” of the operator 16 (whose ID is “BBB”). After similar table look-up procedures, the IM server 10 stores in the viewer list 24 another record showing that “mary” is also watching the “Oscar Movie” from “HBQ.”

To find out the fellow viewers of the “Oscar Movie,” the user 19 requests, via a user interface, the IM device 14 to conduct a search on the IM server 10. The search process locates in the viewer list 24 all the users (including the user 18, “mary”) who are watching “Oscar Movie” at the moment. These users are the user 19's fellow viewers. The user 19 then can request the IM device 14 via a user interface to save the user 18's ID “mary” into the fellow viewer list 25 on the IM device 14.

To establish a user's viewing behavior, another registration process between the IM server 10 and the IM device 14 is required. In this registration process, the IM device 14 sends to the IM server 10, besides the user information, the starting time and end time of the program that the user 19 has watched. For example, the IM server 10 could therefore know that the user 19 has watched the channel “50” of the operator “AAA” from 21:15 to 21:30. From similar table look-up procedures, the IM server 10 knows that, during this interval, the user 19 is watching the program “Oscar Movie.” Then, further based on the nature of the program, the IM server 10 could establish the viewer behavior list 26. In the viewer behavior list 26, corresponding to each user, the individual programs viewed by the user, the program's characteristics, and the starting and end times of the user 19's viewing are all recorded.

Based on such a viewer behavior list 26, a search process could be conducted to locate users who have a preference toward, for example, “Action Movies.” Then “fellow viewer” could be picked from these users and stored in the fellow viewer list 25.

Also based on such a viewer behavior list 26, another search process could be conducted to locate users who have watched a specific program most often. This is achieved by calculating how much time a user has spent on a specific program and sorting out, for example, the top ten users who has spent the longest time on a specific program. Then “fellow viewer” could be picked from these users and stored in the fellow viewer list 25.

Accordingly, the registration and search processes of the IM devices 12 and 14 allow users 18, 19 to locate other users who have similar viewing preference and behavior, and to communicate with them using IM. In the following, the functions of the invitation module 27, fellow status module 29, and user interface 30 will be described in details.

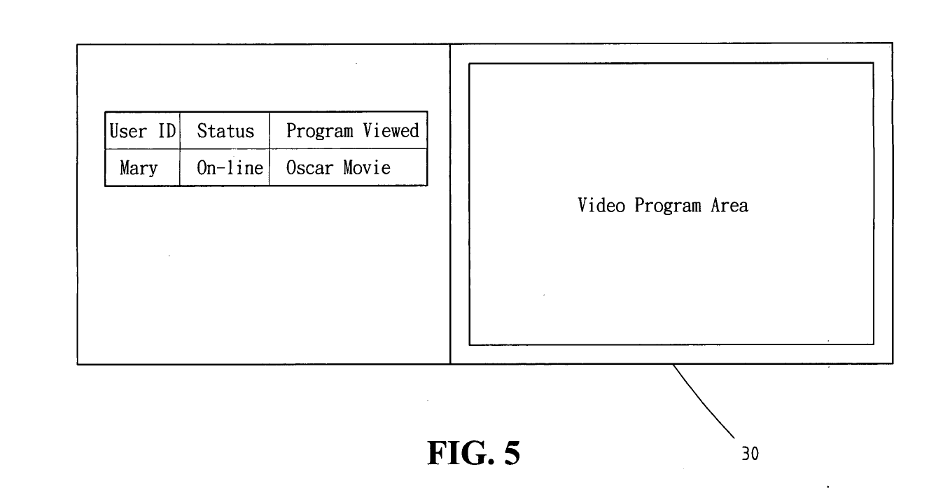

FIG. 5 is a schematic diagram showing the user interface of the IM device according to the present invention. As shown in FIG. 5, the user interface 30 has two separate areas for showing the fellow viewers and the video program respectively. The fellow status module 29 utilizes the viewer list 24 in the IM server 10 and the fellow viewer list 25 in the IM device 14 to determine who in the fellow viewer list 25 is currently watching TV and show these users' IDs and the programs they are viewing in the fellow viewer area of the user interface 30. As shown in FIG. 5, the user “mary”, considered by the user 19 as one of the fellow viewers, is also watching the program “Oscar Movie.”

The invitation module 27 has two functions for two different operating conditions. First, the invitation module 27 in the IM device 14 is activated by the user 19 via the user interface 30 to invite the user 18 shown in the fellow viewer area of the user interface 30 to watch a specific video program. Secondly, when the invitation module 27 in the IM device 12 receives an invitation request from the user 19, the user interface 30 of the IM device 12 would display a message showing the requesting user's ID and the name of the program. If the user 18 confirms the invitation in the displayed message, the reception module 20 of the IM device 12 would switch to receive the program specified in the invitation request.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An instant messaging (IM) device for TV viewers, said IM device, used by a user having a user ID to receive a video program from a channel of an operator and to interact with an IM server, comprising:
a reception module, said reception module receiving said video program, said video program having a corresponding channel ID and an operator ID;
a registration module, said registration module conducting a registration process to send said user ID, channel ID, and said operator ID to said IM server and, after said registration process, capable of accessing a viewer list in said IM server;
a list management module, said list management module conducting search process on said IM server based on said viewer list to establish a fellow viewer list, said fellow viewer list comprising a plurality of user IDs of fellow viewers; and
an IM module, said IM module conducting IM sessions with said fellow viewers.

2. The IM device as claimed in claim 1, wherein said registration process between said IM server and said IM device queries an operator and channel list, using said channel ID and said operator ID as criteria, to obtain a name of a program provider broadcasting said video program, said registration process also queries a program schedule, using said program provider's name as criteria, to obtain a program title of said video program, said registration process records said user ID, said program provider's name, and said program title in said viewer list.

3. The IM device as claimed in claim 2, wherein said operator and channel list comprises a plurality of records, each of which further comprises an operator ID, an channel ID, and a name of a program provider broadcasting on said channel, and said program schedule lists video programs provided by program providers along with said video program's showing times.

4. The IM device as claimed in claim 2, wherein said search process conducted between said IM server and said IM device locates a plurality of user IDs from said viewer list using said program title as criteria, and selects at least one user ID to add into said fellow viewer list.

5. The IM device as claimed in claim 1, wherein said registration process conducted between said IM server and said IM device further provides a viewing start time and a viewing end time of said user's watching said video program, said registration process queries an operator and channel list, using said channel ID and said operator ID as criteria, to obtain a name of a program provider broadcasting said video program, said registration process also queries a program schedule, using said program provider's name as criteria, to obtain a program title and characteristics of said video program, said registration process records said user ID and said user's viewing behavior in a viewer behavior list.

6. The IM device as claimed in claim 5, wherein said viewing behavior comprises said program title, said program's characteristics, and said viewing start time and said viewing end time of said user's watching said video program.

7. The IM device as claimed in claim 6, wherein said search process conducted between said IM server and said IM device locates a plurality of user IDs from said viewer behavior list using said program characteristics as criteria, and selects at least one user ID to add into said fellow viewer list.

8. The IM device as claimed in claim 6, wherein said search process conducted between said IM server and said IM device locates a plurality of user IDs from said viewer behavior list, using a viewing time calculated from said viewing start time and said viewing end time as criteria, who have spent the greatest amount of said viewing time on said video program, and selects at least one user ID to add into said fellow viewer list.

9. The IM device as claimed in claim 8, wherein said users who have spent the greatest amount of said viewing time on said video program are a specific number of users in the front of a list of users sorted by their viewing time on said video program in decreasing order.

10. The IM device as claimed in claim 1 further comprising a viewer status module, said viewer status module, based on said viewer list and said fellow viewer list, showing those fellow viewers who are currently watching a video program, along with said video program's title and provider, in a user interface.

11. The IM device as claimed in claim 1 further comprising an invitation module, said invitation module sending an invitation request to a user of said fellow viewer list to invite said user to watch a specific video program.

12. The IM device as claimed in claim 11 further comprising an invitation module, said invitation module receiving said invitation request and showing a request message having an user ID of a user who sends said invitation request and a title of said specific video program, said invitation module, after said receiving user's confirmation to said request message, causing said reception module to switch to receive said specific video program.

13. An instant messaging (IM) method for TV viewers, said IM method receiving a video program from a channel of an operator and comprising the following steps:
(a) receiving said video program, said video program having a corresponding channel ID and an operator ID;
(b) conducting a registration process to register said user ID, channel ID, and said operator ID and, after said registration process, being able to access a viewer list
(c) conducting a search process to establish a fellow viewer list, said fellow viewer list comprising a plurality of user IDs of fellow viewers; and
(d) conducting IM sessions with said fellow viewers.

14. The IM method as claimed in claim 13, wherein said registration process queries an operator and channel list, using said channel ID and said operator ID as criteria, to obtain a name of a program provider broadcasting said video program, said registration process also queries a program schedule, using said program provider's name as criteria, to obtain a program title of said video program, said registration process records said user ID, said program provider's name, and said program title in said viewer list.

15. The IM method as claimed in claim 14, wherein said operator and channel list comprises a plurality of records, each of which further comprises an operator ID, an channel ID, and a name of a program provider broadcasting on said channel, and said program schedule lists video programs provided by program providers along with said video program's showing times.

16. The IM method as claimed in claim 14, wherein said search process locates a plurality of user IDs from said viewer list using said program title as criteria, and selects at least one user ID to add into said fellow viewer list.

17. The IM method as claimed in claim 13, wherein said registration process further provides a viewing start time and a viewing end time of said user's watching said video program, said registration process queries an operator and channel list, using said channel ID and said operator ID as criteria, to obtain a name of a program provider broadcasting said video program, said registration process also queries a program schedule, using said program provider's name as criteria, to obtain a program title and characteristics of said video program, said registration process records said user ID and said user's viewing behavior in a viewer behavior list.

18. The IM method as claimed in claim 17, wherein said viewing behavior comprises said program title, said program's characteristics, and said viewing start time and said viewing end time of said user's watching said video program.

19. The IM method as claimed in claim 18, wherein said search process locates a plurality of user IDs from said viewer behavior list using said program characteristics as criteria, and selects at least one user ID to add into said fellow viewer list.

20. The IM method as claimed in claim 18, wherein said search process locates a plurality of user IDs from said viewer behavior list, using a viewing time calculated from said viewing start time and said viewing end time as criteria, who have spent the greatest amount of said viewing time on said video program, and selects at least one user ID to add into said fellow viewer list.

21. The IM method as claimed in claim 20, wherein said users who have spent the greatest amount of said viewing time on said video program are a specific number of users in the front of a list of users sorted by their viewing time on said video program in decreasing order.

22. The IM method as claimed in claim 14 further comprising the steps of, based on said viewer list and said fellow viewer list, showing those fellow viewers who are currently watching a video program, along with said video program's title and provider, in a user interface.

23. The IM device as claimed in claim 13 further comprising the steps of sending an invitation request to a user of said fellow viewer list to invite said user to watch a specific video program.

24. The IM method as claimed in claim 13 further comprising the steps of receiving said invitation request and showing a request message having an user ID of a user who sends said invitation request and a title of said specific video program, after receiving user's confirmation to said request message, causing said reception module to switch to receive said specific video program.
